(19) United States
(12) Patent Application Publication
(10) Pub. No.: US 2005/0029989 A1
(43) Pub. Date: Feb. 10, 2005

(54) Battery recharger with timer

(76) Inventors: Christopher A. Recchia, Woodstock, MD (US); David M. Shaver, Brockville (CA)

Correspondence Address: HARNESS, DICKEY & PIERCE, P.L.C., P.O. BOX 828, BLOOMFIELD HILLS, MI, 48303, US

(21) Appl. No.: 10/635,155

(22) Filed: Aug. 6, 2003

(51) Int. Cl. H02J 7/00

(52) U.S. Cl. 320/133

(57) ABSTRACT

A battery charger that has a first mode that charges the battery and a second mode that maintains a charge on the battery. The battery charger switches from the first mode to the second mode after expiration of a predetermined period of time. The battery charger prevents over charging of the battery.

### FIELD OF THE INVENTION

The present invention relates to a battery charger, and more particularly, to a battery charger that switches from a charging mode to a maintenance mode after expiration of a pre-determined period of time.

### BACKGROUND OF THE INVENTION

Rechargeable batteries systems are well known in the art. Typical battery chargers charge the batteries until the battery is removed from the charger or after a predetermined battery condition is reached. As such, typical battery charges may overcharge the battery, which may reduce the efficacy and lifetime of the battery. Additionally, battery chargers that detect the predetermined condition in a battery are necessarily more complex. It is, therefore, desirable to provide a battery charger that does not overcharge batteries and does so without the added complexity of battery condition determination.

### SUMMARY OF THE INVENTION

In accordance with one aspect of the invention, a battery charger has a first mode that charges the battery and a second mode that maintains a charge in the battery. The battery charger switches from the first mode to the second mode after expiration of a predetermined period of time.

Further areas of applicability of the present invention will become apparent from the appended claims and the detailed description provided hereinafter. It should be understood that the detailed description and specific examples, while indicating an exemplary embodiment of the invention, are intended for purposes of illustration only and are not intended to limit the scope of the invention.

### BRIEF DESCRIPTION OF THE DRAWINGS

The present invention will become more fully understood from the appended claims, the detailed description and the accompanying drawings, wherein:

FIG. 1 is a block diagram constructed in accordance with the teachings of the present invention; and

FIG. 2 is an exemplary schematic showing a configuration of the present invention.

### DETAILED DESCRIPTION OF THE PREFERRED EMBODIMENTS

The following description of the preferred embodiments is merely exemplary in nature and is in no way intended to limit the invention, its application, or uses.

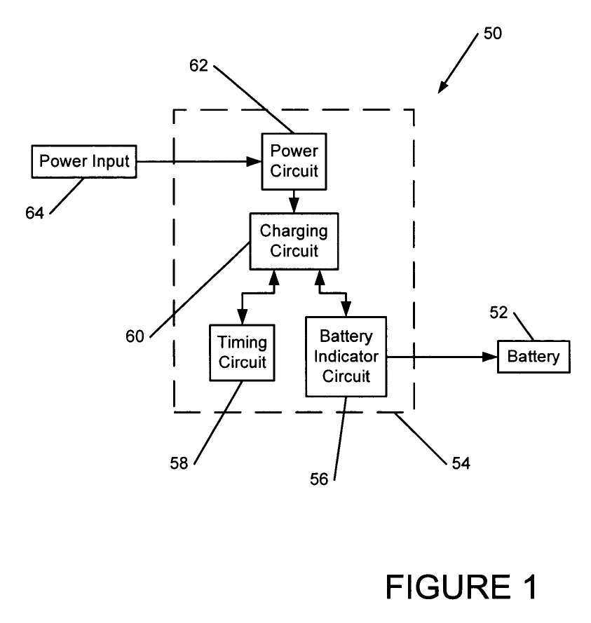

With reference to FIG. 1, a block diagram of the charging system is shown and generally indicated by reference numeral 50. The charging system 50 includes a battery 52, which may be connected to the charging system 50 to initiate charging of the battery. The charging system 50 also includes a charging circuit 60 that is connected to a power circuit 62, a timing circuit 58, and a battery indicator circuit 56, all of which are contained in a pre-configured battery charger 54. A power input 64 provides power to the charging system 50, usually from a residential power source. It should be appreciated that the charging system 50 may be used in various locations and connected to various power sources, such as but not limited to 110 volts 60 Hz, 220 volts 60 Hz, 110 volts 50 Hz, and 220 volts 50 Hz.

The charging system 50 is configured to begin charging when the battery 52 is connected to the charging system 50. The battery indicator circuit 56 is configured to detect the connection of the battery 52. Upon connection of the battery 52, the charging circuit is configured to begin charging the battery 52 for a predetermined period of time. The predetermined period of time is controlled by the timing circuit 58 and can be altered by varying the configuration of the timing circuit 58.

After expiration of the predetermined period of time, the charging circuit 60 switches from charging the battery 52 to maintaining the charge on the battery 52. The charge on the battery 52 is maintained until a user (not shown) removes, thus disconnects, the battery 52 from the charging system 50. The charging of the battery, therefore, is controlled by a predetermined period of time and is independent of a condition of the charge in battery. Only when the predetermined period of time has expired, does the charging system 50 switch from charging the battery 52 to maintaining the charge on the battery 52.

It is envisioned that the predetermined period of time is based on the capacity of the battery 52. For example, a battery that is typically used for consumer applications may have a capacity such that it may be charged for twelve hours. It should be appreciated, however, that the duration of the predetermined time period is variable and may be adjusted due to varying capacities of candidate batteries. It should be further appreciated that the charging system 50 may be used in consumer applications, as well as commercial and industrial applications.

The charging system 50 is preconfigured to mate with the battery 52 and, thus, only requires the battery 52 to be connected to the charging system 50 to initiate charging of the battery 52. More specifically, an exemplary twelve-volt battery need only be inserted into the preconfigured battery charger system to start charging the battery and, to that end, no manual adjustment of the charging system 50 is necessary. It should be appreciated, however, that the present invention may be used with batteries of various capacitates and, as such, the charging system 50 may be configured with various predetermined periods of time.

The battery 52, for example, may be a nickel cadmium battery, with a capacity of about 1.0 amp-hours to about 1.9 amp-hours. The battery may then be connected to the charging system 50 that charges the exemplary battery at about 220 milli-amperes for about 12 hours. After the expiration of the period of time, the charging system switches to a maintenance mode. To that end, a maintenance charge of about 75 milli-amperes to about 100 milli-amperes is applied to the battery when in the maintenance mode.

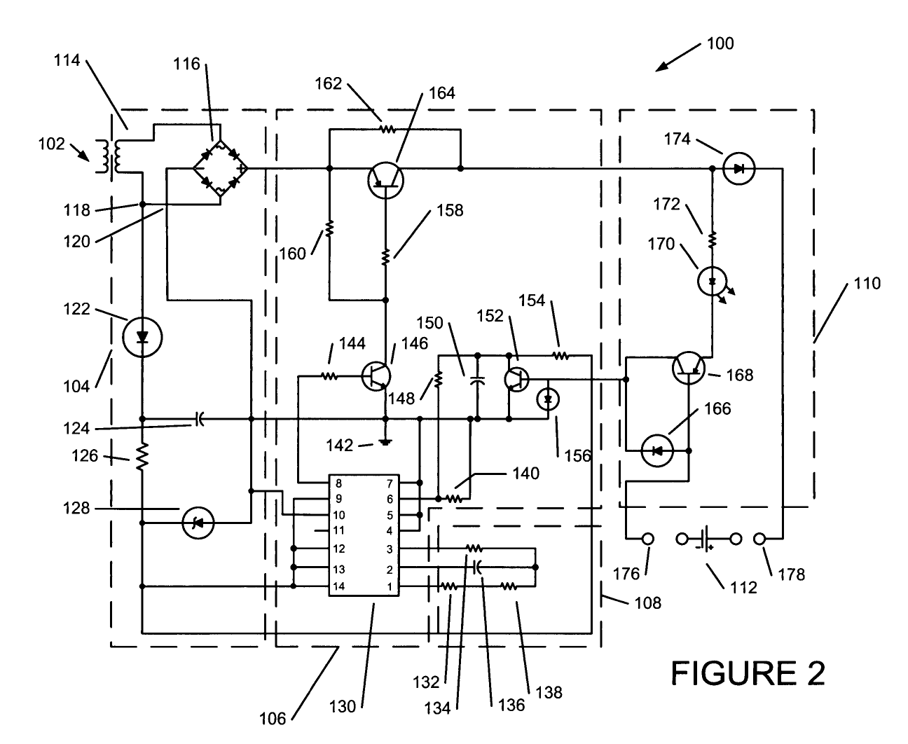

With reference to FIG. 2, an exemplary circuit schematic of the battery charging system constructed in accordance with a configuration of the present invention is shown and is generally indicated by reference numeral 100. It should be appreciated that many designs and variations are possible to implement the present invention and that the circuit schematic depicted in FIG. 2 is just one example. It should be further appreciated that any circuit design that charges a battery for predetermined period of time independent of the condition of the battery is within the scope of the present invention.

The battery charging system 100 includes a power input 102 that is usually connected to a residential power source. It should be appreciated, however, that the battery charging system 100 and the power input 102 may configured to accept various power sources. The battery charging system 100 further includes a power circuit 104, a charging circuit 106, a timing circuit 108, and a battery indicator circuit 110. It follows that a battery 112 may be connected to the battery charging system 100 to charge the battery 112.

Once the battery 112 is connected to the battery charging system 100, the battery indicator circuit 110 recognizes the battery 112 and the charging circuit 106 begins to charge the battery 112 for a predetermined period of time. In the present example depicted in FIG. 2, the predetermined period of time is nine hours and is controlled by the timing circuit 108. It should be appreciated, however, that the amount of time that the battery 112 may be charged is variable and based on the capacity of the battery 112. As such, the period of time may be in the range of eight to thirteen hours or any other suitable duration of time based on the configuration of the battery 112.

Once the predetermined period of time expires, the charging circuit 106 switches to a maintenance mode to maintain a charge in the battery 112. The charge in the battery 112 is maintained until the user (not shown) removes the battery 112 from the battery charging system 100. Removal of the battery 112 necessarily disconnects the battery 112 from the battery charging system 100 and ends the maintenance of the charge in the battery 112.

The power circuit 104 includes a transformer 114, a full-wave rectifier 116, a first diode 122, a first capacitor 124, a first resistor 126, and a Zener diode 128. The individual components of the battery charging system 100 are conventional components available from myriad suppliers. The full-wave rectifier, for example, may be composed of four 1N4002 diodes. The first diode, for example, may be a single 1N4002 diode. The first capacitor, for example, may be a 10 microfarad 50 volt capacitor. It should be appreciated that the power circuit 104 may be constructed with different components and in different configurations. As such, the specific examples offered hitherto and throughout the detailed description are provided for clarity and do not serve to limit the present invention.

The first resistor 126 and the Zener diode 128 of the power circuit 104 may be varied depending on the type of the battery 112 that is used with the battery charging system 100. As such, the first resistor 126 and the Zener diode, for example, may be configured as shown in Table 1 based on the voltage of the battery 112.

TABLE 1

| Battery Voltage | First Resistor | First Zener |
|---|---|---|
| (Volts) | (Ohms) | Diode (Volts) |
| 24 | 1500 ± 5% | 16 ± 5% |
| 18 | 1200 ± 5% | 15 ± 5% |
| 14.4 | 1000 ± 5% | 13 ± 5% |
| 12 | 470 ± 5% | 12 ± 5% |
| 9.6 | 430 ± 5% | 11 ± 5% |

It should be appreciated, however, that the components and the configuration of the battery charging system 100 may be varied based on the configuration of the battery 112 or the power source 102.

It should further be appreciated that a junction in FIG. 2 is shown by reference numeral 118 and defines an electrical junction. An intersection, however, shown by reference numeral 120 indicates that no electrical junction exists even though two or more wires are depicted in FIG. 2 as crossing each other. As such, the junction 118 indicates an electrical connection, while the bridge 120 indicates the absence of an electrical connection between the two or more wires.

The charging circuit 106 connects to the power circuit 104, the timing circuit 108, and the battery indicator circuit 110. The timing circuit 108 includes a second resistor 132, a third resistor 134, a second capacitor 136, and a fourth resistor 138, as depicted in FIG. 2. The second resistor 132 and the fourth resistor 138, for example, may provide a total of three mega-Ohms ±5% of resistance. The third resistor 134, for example, may be an eighth watt 6.8 mega-Ohms ±5% resistor. The second capacitor 136, for example, may be a 0.18 microfarad 100 volt capacitor. The timing circuit 108 may be configured to provide a charging duration of twelve hours, nine hours, or any suitable amount time based on the capacity of the battery 112. It should be appreciated, however, that the components and the configuration of the battery charging system 100 may be varied based on the configuration of the battery 112 or the power source 102.

The charging circuit 106 includes an integrated controller 130 that connects with the power circuit 104 and the timing circuit 108. The integrated controller 130, for example, may be a CD4541BE integrated controller that includes 14 pin-outs and is readily available from many sources. The charging circuit 106 includes a first transistor 146 connected with a fifth resistor 140, a ground 142, and a sixth resistor 144. The fifth resistor 140, for example, may be an eighth watt 0.1 mega-Ohms ±5% resistor. The sixth resistor 144, for example, may be an eighth watt 0.01 mega-Ohms ±5% resistor.

The charging circuit 106 also includes a second transistor 152 connected to a seventh resistor 148, a third capacitor 150, an eighth resistor 154 and a second diode 156. The seventh resistor 148 and the eighth resistor 154, for example, may be eighth watt 3900 Ohm ±5% resistors. The third capacitor 150, for example, may be a 16 volt 47 microfarad capacitor. The second diode, for example, may be a 1N4002 diode.

The charging circuit 106 additionally includes a third transistor 164 connected with a ninth resistor 158, a tenth resistor 160, and an eleventh resistor 162. The tenth resistor 160, for example, may be a 0.1 mega-Ohm ±5% resistor. The ninth resistor 158 and the eleventh resistor 162 of the charging circuit 106 may be varied depending on the type of the battery 112 that is used with the battery charging system 100. As such, the ninth resistor 158 and the eleventh resistor 162, for example, may be eighth watt resistors configured as shown in Table 2 based on the voltage of the battery 112.

TABLE 2

| Battery Voltage | Ninth Resistor | Eleventh Resistor |
|---|---|---|
| (Volts) | (Ohms) | (Ohms) |
| 24 | 20 ± 5% | 3900 ± 5% |
| 18 | 15 ± 5% | 3900 ± 5% |
| 14.4 | 12 ± 5% | 3300 ± 5% |
| 12 | 10 ± 5% | 3900 ± 5% |
| 9.6 | 15 ± 5% | 2000 ± 5% |

It should be appreciated, however, that the components and the configuration of the battery charging system 100 may be varied based on the configuration of the battery 112 or the power source 102.

The charging circuit 106 is configured to charge the battery 112 for a predetermined period of time. After the expiration of the period of the time, the charging circuit 106 is configured to maintain the charge of the battery by applying a maintenance charge. The charging circuit in no way monitors the condition of the battery 112 or makes adjustments to the charging of the battery 112 based on the condition of the battery 112 or the level of charge in the battery 112.

The battery indicator circuit 110 includes a fourth transistor 168 connected with a third diode 166, a light-emitting diode (LED) 170, a twelfth resistor 172, and a fourth diode 174. The third diode 166 and the fourth diode 174, for example, may be 1N4002 diodes. The twelfth resistor 172, for example, may be a quarter watt 5000 Ohm ±5% resistor. The battery indicator circuit 110 also includes a first battery contact 176 and a second battery contact 178.

The first and the second battery contact 176, 178 make contact with the battery 112. The battery indicator circuit 110 and the battery charging system 100 are configured to accept the battery 112 and begin charging the battery 112 when it makes contact with the first and the second battery contact 176, 178. The LED 170 illuminates when the battery 112 has made contact with the first and the second battery contact 176, 178 and the battery charging system 100 is receiving power. It follows, therefore, that the LED 170 will no longer be illuminated when the battery 112 is removed from contact with the first and second battery contact 176, 178.

It should be appreciated that exemplary nickel cadmium batteries discharge at a rate of about 1% per day. It is, therefore, envisioned that the user (not shown) may leave the battery 112 in the battery charging system 100 while not in use. More specifically, after use of a portable power tool (not shown) is complete, the user may remove the battery 112 and connect it with the battery charging system 100, which begins charging the battery. The user may retrieve the battery 112 from the battery charging system 100 when it is needed again. Accordingly, the battery 112 is maintained for its next use without overcharging the battery 112 and without the need to monitor the condition of the battery 112.

The description of the invention is merely exemplary in nature and, thus, variations that do not depart from the gist of the invention are intended to be within the scope of the invention. Such variations are not to be regarded as a departure from the spirit and scope of the invention.

1. A battery charger comprising:
a charging mode that completes charging after an event, wherein said event essentially consists of an expiration of a period of time.

2. The battery charger of claim 1 further comprising a maintenance mode to maintain a charge.

3. The battery charger of claim 2, wherein said maintenance mode begins after said event.

4. A device for charging a battery comprising:
a battery charger having a first mode that charges the battery and a second mode that maintains a charge in the battery, wherein said battery charger switches from said first mode to said second mode after expiration of a predetermined period of time.

5. The device of claim 4, wherein said predetermined period of time is based on a capacity of the battery.

6. A battery charger comprising:
a charging circuit for charging a battery and maintaining a charge of said battery; and
a timing circuit for switching the charging circuit from charging said battery to maintaining said battery after an expiration of a predetermined period of time.

7. The battery charger of claim 6 further comprising a battery indicator circuit that detects a presence of said battery, wherein said presence of said battery causes said charging circuit to begin charging said battery.

8. The battery charger of claim 6 wherein said predetermined period of time is based on a capacity of said battery.

9. A method of charging a battery in a battery charger comprising:
placing the battery in the battery charger;
activating a charging circuit;
charging the battery for the predetermined period of time;
switching the charging circuit from charging the battery to maintaining a charge on the battery after an expiration of the period of time; and
maintaining a charge on the battery.
